(19) United States
(12) Patent Application Publication
(10) Pub. No.: US 2001/0043164 A1
(43) Pub. Date: Nov. 22, 2001

(54) CLOTHING WITH IMAGE DISPLAY

(76) Inventors: GREGORY B. THAGARD, LOS ANGELES, CA (US); JOHN H. DARGAN, VERDES ESTATES, CA (US); RANDOLPH M. BLOTKY, LOS ANGELES, CA (US)

Correspondence Address: GOTTLIEB RACKMAN & REISMAN PC, 270 MADISON AVENUE, 8TH FLOOR, NEW YORK, NY, 100160601

(21) Appl. No.: 09/300,042

(22) Filed: Apr. 27, 1999

(51) Int. Cl. G09G 5/00

(52) U.S. Cl. 345/7

(57) ABSTRACT

Apparel that incorporates an electronic display. A controller is associated with the electronic display and includes a driver and a memory holding data representative of an image to be displayed. The controller generates commands for the display elements based on the data. Various monochromatic, or color images of real or imaginary objects as well as alphanumeric characters may be shown on the display. Additionally, the images may include static or dynamic images. The invention can be adapted to a wide range of clothing including shirts, vests, jackets, caps, ties, belts, suspenders, umbrellas and so on. The invention may also be incorporated into an apparatus used for war games, whereby sensors included in or disposed adjacent to the display can be used to detect “hits” from other participants.

### BACKGROUND OF THE INVENTION

A. Field of Invention

This invention pertains to articles of clothing incorporating various images consisting of alphanumeric characters and/or graphic elements and, more particularly, clothing apparel bearing monochromatic or polychromatic images which may be changed at will. The invention further pertains to apparel that display images that may include static elements or dynamic (i.e., moving) images.

B. Description of the Prior Art

Many casual articles of clothing such as hats, T-shirts, jackets and so, worn today by the average consumer, bear decorations which consist of alphanumeric characters , graphic elements, or both. Sports fans wear clothing with images identifying the names and logos of their favorite teams, or the name and the picture of their favorite player. Music fans typically wear clothing bearing the names of rock stars and/or the emblems of their favorite band. Tourists buy T-shirts and hats emblazoned with the names of cities and images of attractions all over the world. Many companies and organizations provide their employees, and/or the public at large, with clothing bearing their names and logos. Additionally, policemen, highway construction workers and military and law enforcement personnel frequently wear clothing bearing symbols or other images and characters rendering them highly visible and readily identifiable.

Until now, clothing bearing images could be made only by: (1) embedding, e.g., by weaving or knitting, the images into the fabrics; or (2) applying appliques with the images to the clothing.

These methods have one characteristic in common: they give rise to images which are permanent and therefore difficult to remove or change.

### OBJECTIVES AND SUMMARY OF THE INVENTION

In view of the above, it is an objective of the present invention to provide apparel bearing an electronic display which is adapted to show different images.

A further objective is to provide a display which can be incorporated into or attached to clothing, the display being capable of showing electronic images including alphanumeric elements and/or graphic elements.

A further objective is to provide clothing which is combined with a display and speakers for reproducing sounds and images for multi-media presentations.

Other objectives and advantages of the invention shall become apparent from the following description.

Briefly, a display for apparel is made in accordance with this invention from a flexible material such as a light emitting polymer, or similar material which can be electronically activated to show images in response to electronic signals. The display is coupled to a control circuit which includes a driver generating signals for the electronic display, a memory for storing data corresponding to the images to be displayed, and a power supply for powering the circuitry and the display itself. The display may be used to show an image consisting of alphanumeric characters and other graphic elements. These elements may be changed selectively by the wearer, at regular intervals, at predetermined times (for example, different times of the day), or in response to various other stimuli. The images may be either static or dynamic, and may be in black-and-white or color.

The circuitry may include coupling means for receiving data from the outside world. These coupling means may include standard computer interfaces, RF, IR or ultrasonic couplings, or other similar data transmission devices.

The displays may also be incorporated into shirts, vests, hats, suspenders, belts, ties, umbrellas and so on.

### BRIEF DESCRIPTIONS OF THE DRAWINGS

FIG. 1 is a front view of a vest with a display constructed in accordance with the invention;

FIG. 2 is a partial cross-sectional view of the display of FIG. 1;

FIG. 3 is a block diagram of the control circuit 20 of FIG. 1;

FIG. 4 shows a front view of a T-shirt with a display constructed in accordance with the subject invention;

FIG. 5 shows a side view of a sports cap with a display constructed in accordance with the subject invention;

FIG. 6 shows a front view of a neck tie with a display constructed in accordance with the subject invention;

FIG. 7 shows a perspective view of a belt with a display constructed in accordance with the subject invention;

FIG. 8 shows a pair of suspenders with a display constructed in accordance with the subject invention;

FIG. 9 shows a vest with a display constructed in accordance with an alternative embodiment of the subject invention and other equipment adapted to be used in a war game; and

FIG. 10 is a block diagram of the control circuit 204 of FIG. 9.

### DETAILED DESCRIPTION OF THE INVENTION

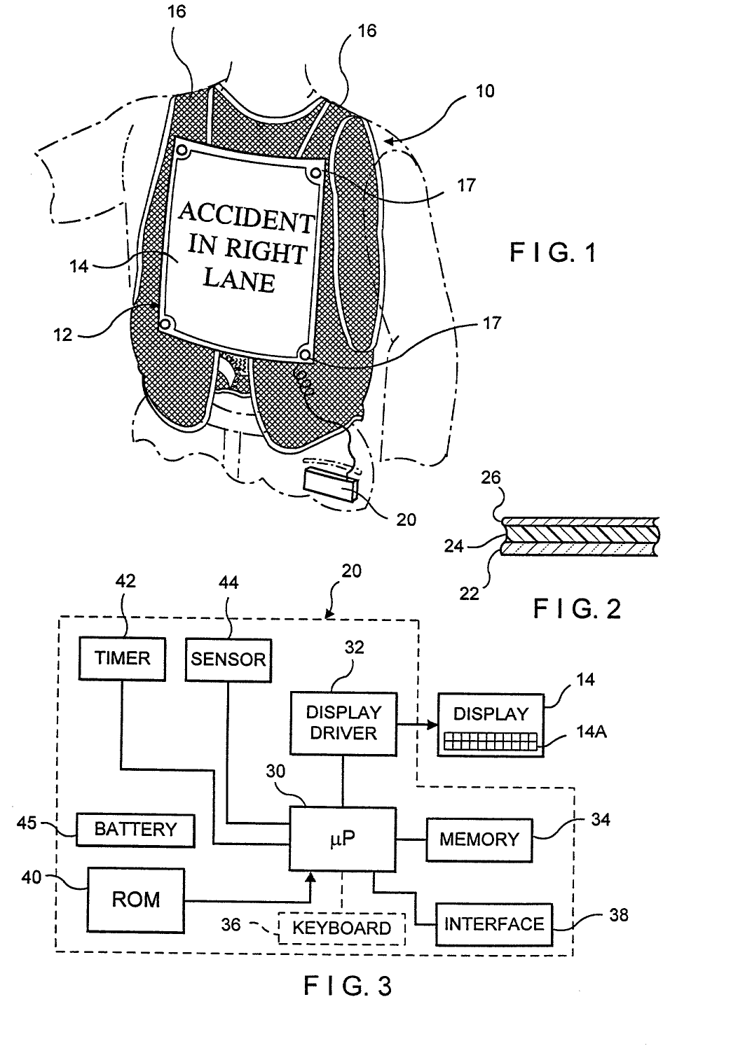

In the embodiment of FIG. 1, the vest 10 may be worn, for example, by a police officer directing traffic. In this embodiment, motorists and emergency/service personnel are advised that an accident occurred in the right lane. The vest 10 includes a front panel 12 having a display 14 and a pair of straps 16 holding the vest in place on the body of the wearer. The vest 10 further includes a back panel (not shown). The back panel may include its own display area or it may be a standard fabric panel without a display. The front panel 12 may be made integral with the vest or it may be attached to the vest by snaps 17 or other fastening means, as discussed more fully below.

Provided with vest 10 there is a control box 20 used to control the message or images shown on the display 14. Details of the control box 20 are discussed below in connection with FIG. 3.

As shown in FIG. 2, display 14 on front panel 12 consists of three layers: a base 22 which may be any typical woven, non-woven or knitted fabric, a layer 24 made of a light emitting polymer (LEP) material, and a transparent or translucent protective layer 26 extending over layer 24. A suitable LEP material is available from Cambridge Display Technology of Cambridge, U.K.

An image is generated on the display 14 as follows. Control box 20, as indicated in FIG. 3, includes a microprocessor 30, a display driver 32 and a memory 34. An optional keyboard 36 is also included in the Figure to represent a means of entering information and/or selecting various images stored in memory 34. These images may include alphanumeric characters forming a message (as shown in FIG. 1) and/or various esthetic and ornamental designs.

When the user selects an image using keyboard 36, the microprocessor 30 retrieves the data corresponding to the selected image and provides appropriate commands to the display driver 32. Display driver 32 then sends signals to the display 14 to cause the selected image to appear thereon. Typically, the display 14 may be formed of a two dimensional array of pixels 14A. It should be understood that for the purposes of this invention, the term “image” is used broadly to indicate any desired effect on the display 14. For example, the display 14 can be rendered to be completely red, white, yellow or any other color by rendering on the display a featureless image of the desired color.

Alternatively, or in addition to keyboard 36, control box 20 may also be provided with an interface 38 to couple the control box 20 to an external device such as a laptop or a personal computer. For this purpose, the interface 38 may be a parallel port, a serial port, a USB port, etc. The interface 38 may even be a radio receiver.

Power to the circuitry of the control box 20 shown in FIG. 3, as well as to display 14, is provided by a battery 45.

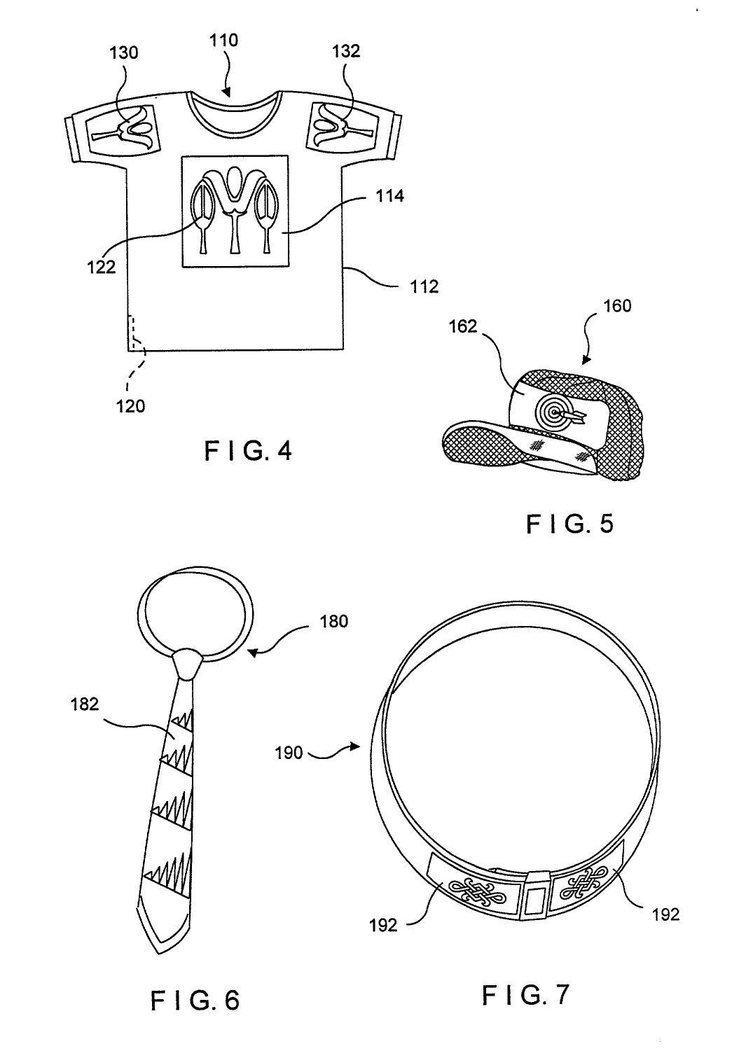

In the embodiment of FIGS. 1-3, the display 14 is utilized to show a simple image consisting of an alphanumeric message. A similar arrangement may be used to display other, more complex, images. For example, FIG. 4 shows a T-shirt 110 having a front panel 112 with a display 114. Attached to one side of the T-shirt is a small control box 120 similar to control box 20 of FIG. 3. The display may be used to show the name and logo of a team, a picture of a team player, and other monochromatic or color images.

The T-shirt 110 differs from the vest 10 in that its display normally shows only a single image which cannot be changed by the wearer, or one that is changed by the wearer at infrequent intervals. For this purpose, the control box 120 may be provided with a replaceable memory element such as a flash ROM 40 (see FIG. 3). In one embodiment, the control box 120 is sealed so that T-shirt 110 can show only a single ornamental and/or alphanumeric image on its display 114. In another embodiment, the control box 120 is arranged to allow its ROM 40 to be changed. Each ROM 40 then provides a different image 122.

Each image on the display 14 of vest 10 or T-shirt 110 can be static or dynamic, monochromatic or in color, of live persons or scenery. Additionally, a sequence of images may be shown to generate moving images including a feature animation.

Using the technology disclosed herein, images may be generated on other parts of the T-shirt, including, for instance, the sleeves, as illustrated in FIG. 4 at 130, 132 . The images for these displays can be generated by the single control box 120, or if necessary, by several different circuits.

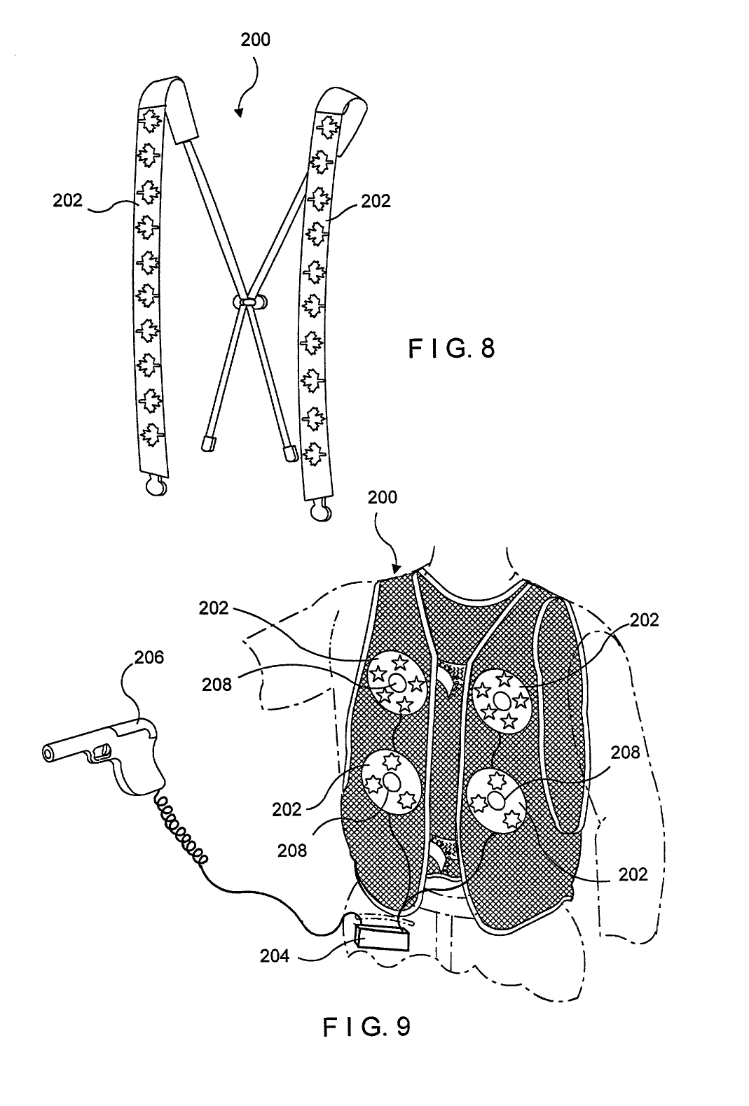

Moreover, the disclosed structure and arrangement is not limited to T-shirts or vests but can be used on jackets, shirts, and other apparel. For example, FIG. 5 shows a baseball cap 160 with a display 162, FIG. 6 shows a tie 180 with a display 182, FIG. 7 shows a belt 190 with a display 192, and FIG. 8 shows a pair of suspenders 200 with displays 202.

FIGS. 1-8 represent just some of the apparel that may incorporate displays. Other apparel may include shirts, shorts, umbrellas and so on.

In FIGS. 1-8, the depicted displays are shown as covering the respective apparel only partially, but importantly, the displays can be large enough to completely cover the visible portions of these apparel. In this latter configuration, the color of clothing can be changed at will, or automatically. The images generated on the displays discussed above may be controlled and changed by the control box 20 in accordance with certain predetermined criteria. For example, the control box 20 may include a timer 42 which can be set to define certain intervals. A different color, pattern or image can be assigned to each time interval. The microprocessor 30 then selects the respective color, pattern or image for each time interval and causes the same to be shown at the appropriate time on display 14.

Alternatively, the control box 20 may include a light sensor 44. When the sensor 44 detects daylight, one color, color scheme or image is shown on the display, while a different color, color scheme or image is displayed at night.

Another area in which apparel bearing images may be used is in the field of athletics.

Participants in athletic activities as well as spectators and fans wear apparel bearing the team names and sponsors. A T-shirt as shown in FIG. 4 worn by a fan with one or more displays is ideally suited to show either sequentially or simultaneously the name of a team, the name of a sponsor, the names of several products of the sponsor and so on. In fact, the display 114 can run a short advertisement made up of moving images.

One popular recreation activity is a war game played between teams in which team members are equipped with laser beams or other light sources and their clothing is equipped with sensors which detect when a participant is ‘hit’ with the laser beam from a member of another team. The present invention is readily applicable for use in this kind of activity. Referring to FIG. 9, the equipment for playing a war game includes a vest 200 with several displays 202, a control box 204 and a gun 206. The control box 204 includes the standard components discussed above for showing images on displays 202, selected to attract or detract attention from the wearer. The displays 202 may also be provided on the back of the vest 200, the arms, the legs and other body parts as well.

The gun 206 is constructed to generate signals having predetermined characteristics. For example, the gun 206 may generate a laser beam of a preselected wavelength and intensity, a high intensity light beam, etc. The gun 206 may be coupled to control box 204 so that the control box 204 can control and monitor the operation of the gun 206. For example, the control box 204 may be used to activate the gun 206 at the beginning of a play period, and to deactivate the gun 206 at the end of the play period.

The vest 200 includes not only one or more displays 202, but also one or more sensors 208 disposed on or attached adjacent to corresponding displays 202 and arranged to register a ‘hit’ by another player.

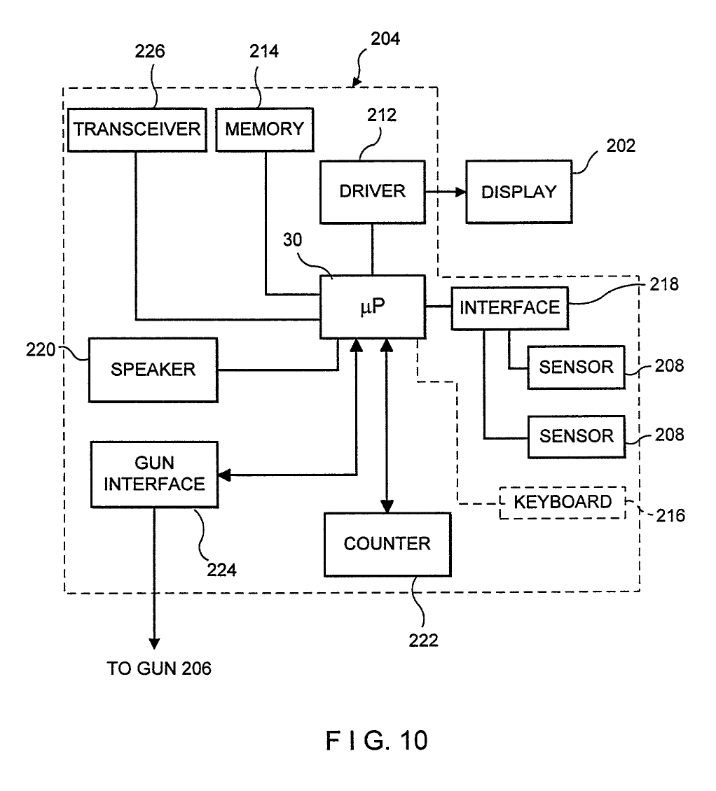

Referring now to FIG. 10 the control box 204 for this embodiment includes a microprocessor 210 associated with a display driver 212 for generating signals for a representative display 202, a memory 214 and a keyboard 216. The memory 214 is used to store data for various images to be shown on display 202. The keyboard 216 or other similar means may be used to select the images to be shown by displays 202 and to enter various control parameters required to operate the equipment. The control box 204 further includes an interface 218 receiving signals from sensors 208 and transmitting signals to the microprocessor 210. In response to a hit, the microprocessor 210 may determine whether the player is permanently or temporarily disabled. For example, a hit on the chest area may result in a determination that the wearer has been “fatally” hit, while a hit on an arm or a leg may result in a temporary disablement. The sensors 208 may include light (IR and/or laser) sensors, proximity sensors, and so on, and can be highly localized.

The control box 204 further includes a speaker 220, a counter 222, a gun interface 224, and a transceiver 226. The speaker 220 may be used to generate various sound effects indicative, for example, of the wearer being hit as indicated by the sensors 208. The counter 222 may be used to indicate each time the wearer has been hit and/or when he has scored a hit on another player. The gun interface 224 is used to control the gun 206 as discussed above.

The transceiver 226 may be used to communicate with a central location and/or other players and exchange various messages regarding hits by or on the wearer, the start and end of a game and so on. The transceiver 226 may also be used to download images to be stored in memory 214. The speaker 220 may be an internal speaker or may be a flat external speaker mounted on the vest 200.

It should be noted that many of the components shown in FIG. 10, such as the speaker 220, can be used in any of the previously described embodiments as well.

In summary, the present invention pertains to apparel which incorporates a display, preferably making use of a light emitting polymer. The display is either integral with the apparel, or is selectively attached to the apparel by snaps, Velcro® fasteners, or other similar means. The size of the display area, and hence the images that can be displayed, is dependent on the apparel itself. For a relatively large apparel such as a jersey, T-shirt or jacket, the display can be up to 11×16″ or even larger, and comprise 640×480 pixels. Moreover, the display can be used to show either static images or dynamic images. For example, if memory 34 or 214 is a 1 Mbyte memory, it can hold enough data to show a five-second color video.

The data for defining the images can be downloaded into the memory using either an RF link, an IR link or a direct serial, parallel or USB port. Alternatively, a replaceable memory unit such as a flash ROM can be used to select the images to be displayed.

Obviously numerous modifications may be made to this invention without departing from its scope as defined in the appended claims.

We claim:

1. Apparel to be worn by a person, comprising:
a panel, said panel including a display;
a control member generating signals for said display to form images thereon;
a memory coupled to said control member, said memory storing data defining images for said display; and
a securing member arranged to secure said panel on the body of said person.

2. The apparel of claim 1 wherein said display is integrally incorporated into said panel.

3. The apparel of claim 1 wherein said display is formed of a light emitting polymer.

4. The apparel of claim 1 wherein said display is constructed to show color images in response to said signals.

5. The apparel of claim 1 wherein said control member and said memory cooperate to generate a static image on said display.

6. The apparel of claim 1 wherein said control member and said memory cooperate to generate a dynamic image on said display.

7. The apparel of claim 1 wherein said memory is arranged to store several images, said apparel further comprising a selection member coupled to said control member to select one of said images for said display.

8. The apparel of claim 1 wherein said control member generates signals defining a monochromatic image on said display.

9. The apparel of claim 8 wherein said monochromatic image is a uniform color.

10. The apparel of claim 8 wherein said control member generates signals defining an image composed of alphanumeric characters.

11. The apparel of claim 10 wherein said control member generates an image having elements defining a predetermined pattern.

12. The apparel of claim 1 wherein said display is sized and arranged to be mounted on a vest.

13. The apparel of claim 1 wherein said display is sized and arranged to be mounted on a shirt.

14. The apparel of claim 1 wherein said display is sized and arranged to be mounted on a cap.

15. The apparel of claim 1 wherein said display is sized and arranged to be mounted on a tie.

16. The apparel of claim 1 wherein said display is sized and arranged to be mounted on a pair of suspenders.

17. The apparel of claim 1 wherein said display is sized and arranged to be mounted on a belt.

18. Apparel for a wearer comprising:
a clothing article constructed and arranged to be worn on the body of said wearer;
an electronic display associated with said clothing article;
a controller associated with said electronic display and having a memory holding data representative of at least one image; and
a control member coupled to said memory to receive said data and to generate signals for said electronic display to show said at least one image.

19. The apparel of claim 18 wherein said memory is replaceable to change said image.

20. The apparel of claim 18 wherein said memory is arranged to hold data representative of several images and wherein said controller includes an image selector for selecting one of said images to be displayed.

21. The apparel of claim 20 wherein said image selector includes a timer to generate a timing signal and wherein said display shows images in accordance with said timing signal.

22. The apparel of claim 20 wherein said controller and display cooperate to generate images including alphanumeric characters.

23. The apparel of claim 20 wherein said image selector includes a keyboard for identifying said at least one image.

24. The apparel of claim 18 wherein said display images are formed of alphanumeric characters.

25. The apparel of claim 18 further comprising a message selector cooperating with said controller to select a message formed of alphanumeric characters, said message being shown on said display.

26. The apparel of claim 25 wherein said message selector includes a keyboard for entering said alphanumeric characters.

27. The apparel of claim 25 wherein said message selector includes an interface receiving signals from an external device, said signals defining said message.

28. Apparatus for playing a war game comprising:
clothing constructed to be worn by a participant in said war game;
an electronic display formed on said clothing and arranged to show selectively one of a plurality of images;
a controller generating signals for said electronic display, said signals defining said images; and
a gun coupled to said controller, said gun generating a beam when activated by said participant.

29. The apparatus of claim 28 further comprising a sensor sensing hits on said participant from other participants.
